(19) United States
(12) Patent Application Publication
(10) Pub. No.: US 2006/0191013 A1
(43) Pub. Date: Aug. 24, 2006

(54) Offering different product costs options based on privacy policy acceptance

(76) Inventors: Mark A. Collins, Dripping Springs, TX (US); Christopher S. Boesch, Austin, TX (US)

Correspondence Address: HAMILTON & TERRILE, LLP, P.O. BOX 203518, AUSTIN, TX, 78720, US

(21) Appl. No.: 11/064,636

(22) Filed: Feb. 24, 2005

(51) Int. Cl. H04N 7/16; H04L 9/00; H04L 9/32; H04K 1/00; G06F 17/30; G06F 7/04; G06K 9/00; H03M 1/68

(52) U.S. Cl. 726/26; 713/182

(57) ABSTRACT

A system for enabling configuration of an information handling system which includes a configurator, a support authorization module for enabling a user to authorize access to the information handling system to provide support for the information handling system, and a database. The database receives information from the support authorization module regarding whether remote access of the information handling system is authorized. The configurator configures a system with options selected according to user input.

### BACKGROUND OF THE INVENTION

1. Field of the Invention

The present invention relates to supporting information handling systems, and more particularly, determining a level of support based upon privacy policy acceptance.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

A first generation web based on-line store provided a customer with an ability to select a base information handling system, customize the system and price it. Such an on-line store focused initially upon the bare necessities. That is, build a system and get a price. A configurator allowed the customer to customize and procure the system on-line. The configurator allowed the customer to select a given system model and to customize the system according to the user selected options. Such a configurator was most well received by knowledgeable customers, that is, those who were very self-sufficient without the assistance of a sales representative.

Known on-line stores included a web objects based application providing the capability to custom configure and order a particular system. The initial on-line store application offered customers the ability to select and price key system options, the ability to include multiple systems on a single order, and the ability to provide information necessary for the placement of a standard system order.

The capability to self-select system options and then price the options was provided via an on-line configurator. This configurator enabled customer selection of key, system-defining components from a display of available system options for a chosen system. The display of available options included the presentation of a “delta” price, wherein a change in system price was affected by selection of an option. The configurator provided the ability to update overall system priced based upon selections made. The capability to include multiple items in a single order was afforded by the presence of a “shopping cart,” wherein the shopping cart represents an equivalent to the traditional shopping cart. The shopping cart enabled customers to group disparate systems together as an order, as well as specify a quantity for each individual system to be included on the order. Furthermore, the capability to provide customer-specific information required for the placement of a standard order was provided via an on-line “checkout,” the checkout including essentially a form for facilitating the capture of requested and required information. The checkout form included simple logic rules to assure entry of the required fields.

One issue relating to information handling system suppliers is how to minimize support costs. The support costs for information handling systems rises as customers perform operations or installations on their information handling systems. This issue becomes more pronounced when a system supplier provides ancillary service access such as music download services or photography services.

When a customer performs operations such as application installation, music download or photography ordering services, or other types of information downloads such as downloads via the Internet, applications such as plug-ins, spyware or viruses may also be installed onto the customer's information handling system. This additional application installation is often unbeknownst to either the customer or to the information handling system supplier. These additional installed applications can have an adverse affect on the operation of the information handling system that are often difficult to diagnose when the customer initiates a support call to the information handling system supplier.

Some types of information handling system suppliers request the ability to track customer data for their own use to help drive up a customer experience acceptance of their products. However, often customer acceptance of this ability is less than desired for the information handling supplier.

### SUMMARY OF THE INVENTION

In accordance with the present invention, a system which provides an incentive for a customer to accept a more relaxed privacy arrangement so as to facilitate customer support is disclosed.

In one embodiment, the invention relates to a system for enabling configuration of an information handling system which includes a configurator, a support authorization module for enabling a user to authorize access to the information handling system to provide support for the information handling system, and a database. The database receives information from the support authorization module regarding whether remote access of the information handling system is authorized. The configurator configures a system with options selected according to user input.

In another embodiment, the invention relates to a method for enabling configuration of an information handling system which includes configuring a system with options selected according to user input, enabling a user to authorize access to the information handling system to provide support for the information handling system, and receiving information from the support authorization module regarding whether remote access of the information handling system is authorized.

In another embodiment, the invention relates to an apparatus for enabling configuration of an information handling system which includes means for configuring a system with options selected according to user input, means for enabling a user to authorize access to the information handling system to provide support for the information handling system, and means for receiving information from the support authorization module regarding whether remote access of the information handling system is authorized.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows an overview block diagram representation of an on-line store.

FIG. 2 shows access to the on-line store via the Internet using a computer system.

FIG. 3 shows a system block diagram of an information handling system.

FIG. 4 shows a block diagram showing the operation of a remote support application.

### DETAILED DESCRIPTION

An on-line store is one component of an Internet website to which a customer may go to configure a particular information handling system, for example, according to desired options of the customer. The on-line store is typically a subset of a larger Internet website. At the on-line store, a customer can select one or more products in which the customer is interested. Upon selection of a particular product, the on-line store presents the customer with the ability to go to the product information for the particular product, customize the product, price the customized product, purchase the product, and other actions as discussed herein. While shopping happens in the website (i.e., selection of a particular kind of system by a customer), when the customer is ready to purchase a customized system, the customer is then directed to that part of the website which the on-line store application controls.

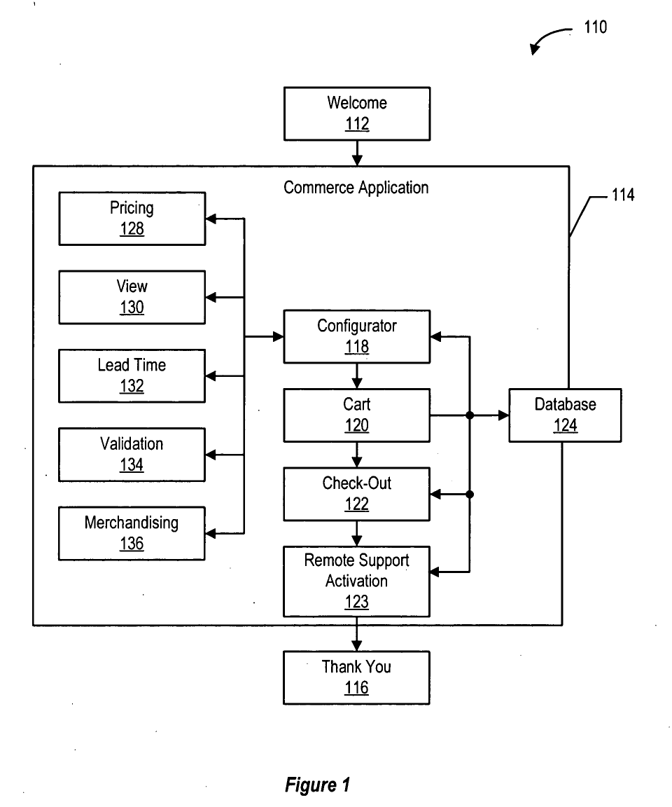

Referring now to FIG. 1, an on-line store 110 for use in generating customer configured information handling systems, e.g., customer configured computer systems, is shown. The on-line store 110 includes a welcome or introductory module 112, a commerce application module 114, and a thank you module 116. The on-line store 110 includes an on-line store user interface which enables the system configuration, pricing, and ordering of an information handling system via the Internet. The commerce application 114 includes a configurator 118, shopping cart 120, a checkout module 122, a remote support activation module 123 and database 124. The database 124 provides information to the configurator 118, shopping cart 120, checkout module 122 and remote support activation module 123. The configurator 118 includes a pricing module 128, a view module 130, a lead time warning module 132, a validation (or compatibility) warning module 134, and a merchandising module 136. The various modules of the configurator 118 are driven by data from the database 124, and thus the configurator 118, shopping cart 120, checkout module 122 and remote support activation module 123 are all linked to the database 124.

In operation of the on-line store 110, the welcome module 112 presents a welcome page 112, the configurator 118 presents a configurator page, the shopping cart 120 presents a shopping cart page, the checkout module 122 presents a checkout page, the remote support activation module 123 presents a remote support activation page, and the thank you module 116 presents a thank you page. The welcome page includes a static page and generally resides outside of the commerce application 114. The configurator page, shopping cart page, checkout page and services activation page are within the commerce application and use information provided by the database. The checkout includes a payment feature, delivery feature, personal verses business feature, and instructional text features (i.e., how to fill out an on-line form.)

The welcome page is typically an introductory page and includes a link into the on-line store 110. The welcome page is typically a static welcome page. Upon completion of configuration of a system, the customer is transferred to a checkout page. After completion of the checkout, a customer is transferred to a remote support activation page in which the customer is provided an opportunity to allow remote support services by for example, the information handling system supplier. After completion of the remote support activation module 123, the customer is transferred to a static thank you page 116. The thank you page 116 provides a message of gratitude to the customer for having placed the order or for visiting the on-line store.

Aspects of the configurator 118 which interact with database 124 are shown in FIG. 1. In essence, the entire commerce application 114 interacts with the database. The configurator 118, shopping cart 120, checkout module 122 and remote support module 123 are each part of the commerce application 114 and interact with the database 124. For example, with the shopping cart 120, additional merchandising information associated with a particular system which has been configured and placed in the shopping cart by an on-line store customer can be provided.

Also for example, various support services may be provided for order by the customer by the remote support activation module 123 based upon the type of system ordered as well as components that are included within the system ordered. Additionally, the remote support activation module 123 might provide incentives to the customer to authorize a more relaxed privacy arrangement. Additionally, by providing the support activation module within the commerce application 114, the customer continues the experience a similar customer experience and the system provider is able to use the information from the database 124 to maintain control over the customer contact. By maintaining control over the customer contact the system provider is able to determine what support services are activated and to maintain accurate and up to date records of the support service activation.

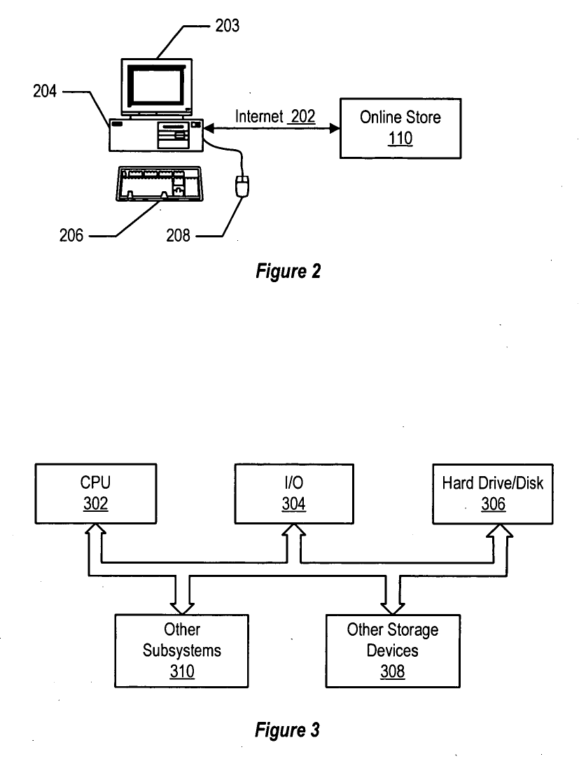

Referring to FIG. 2, a customer can access the on-line store 110 using any suitable computer equipment 200, via the Internet 202. The computer equipment 140 may include a display 203, computer 204, keyboard 206, and pointing device 208. Display 203 is used for displaying the various pages of the on-line store while a customer is using the on-line store.

Referring briefly to FIG. 3, a system block diagram of an information handling system 150 is shown having features thereof configured in accordance with the on-line store 110 as discussed herein. The information handling system 150 includes a processor 302, input/output (I/O) devices, such as a display, a keyboard, a mouse, and associated controllers, collectively designed by a reference numeral 304, a hard disk and drive 306, and other storage devices, such as a floppy disk and drive and other memory devices, collectively designated by a reference numeral 308, and various other subsystems, collectively designated by a reference numeral 310, all interconnected via one or more buses, shown collectively as a bus 312.

For purposes of this invention, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

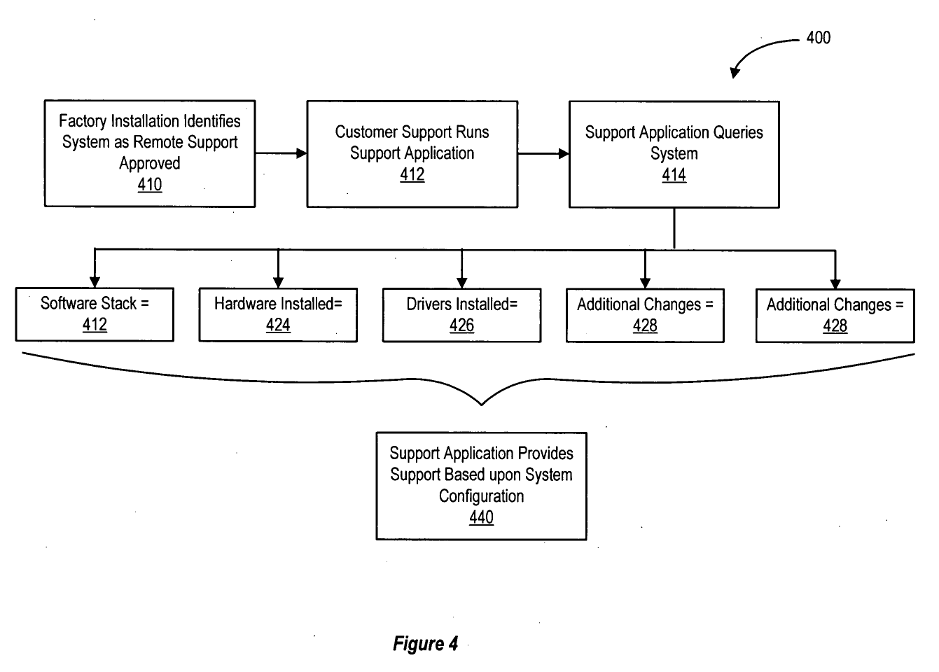

Referring to FIG. 4, a block diagram showing the operation of a system for authorizing remote support 400 is shown. More specifically, the factory installation process identifies the system 300 as remote support approved and stores all support content onto the system 300, in e.g., the hard drive of the system 300 at step 410. When the system 120 is shipped to the customer, the customer may request support on the system 300 at step 412. The remote support application then remotely performs queries of the system 300, (e.g., XPATH queries or SDR queries) to determine particular services or components that were installed based upon the customer's activities at step 414. For example, the remote support application determines the software stack configuration of the system 300 at step 422, what hardware configuration of the system 300 is at step 424, what drivers are installed on the system at step 426. The remote support application also identifies any changes to the system 300 from the last known configuration of the system at step 428. These changes can include hardware changes such as the addition of new hardware components within the system or software changes such as the installation of new application programs. The changes may also be changes that are not readily apparent to the customer such as the installation of plug-in applications, the installation of new software updates, or the installation of spyware unbeknownst to the customer. These changes can also be an identification of when a most recent virus check was performed.

The remote support application can also present other types of support queries to the system 300 at step 430. These other types of support queries might include for example, whether the system has the most up to date operating system updates, the most up to date application program updates, when a most recent virus check was performed, or any other type of query that would assist in diagnosing and addressing problems within the information handling system, both those that prompted the support request and those of which the customer might be unaware.

Based upon the support queries, the remote support application provides support based upon the system configuration at step 440.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Also, for example, the remote support activation module 123 which interacts with the database 124 may be used by a telephone sales person when a system is being ordered via the telephone. In this situation, the information that is derived by the telephone sale person during a customer interview is then used to provide the customer with the option of services activation. Accordingly, the customer continues the experience a similar customer experience and the system provider is able to use the information from its database and to maintain control over the customer contact. By maintaining control over the customer contact the system provider is able to determine what support services are activated and authorized and to maintain accurate and up to date records of the support service activation.

Consequently, the invention is intended to be limited only by the spirit and scope of the appended claims, giving full cognizance to equivalents in all respects.

What is claimed is:

1. A system for enabling configuration of an information handling system comprising:
a configurator, the configurator configuring a system with options selected according to user input;
a support authorization module for enabling a user to authorize access to the information handling system to provide support for the information handling system; and
a database, the database receiving information from the support authorization module regarding whether remote access of the information handling system is authorized.

2. The system of claim 1 wherein:
the support authorization module provides the user with an incentive to authorize a relaxed privacy arrangement.

3. The system of claim 2 wherein:
the incentive relates to support of the information handling system.

4. The system of claim 2 wherein:
the incentive includes an extended service period for which support is provided.

5. The system of claim 2 wherein:
the incentive includes a reduced cost extended service plan for support of the information handling system.

6. The system of claim 1 wherein
the service activation module enables a user to authorize support based upon the options selected according to user input.

7. The system of claim 1 wherein the support authorization module generates information relating to the support authorized by the user.

8. A method for enabling configuration of an information handling system comprising:
configuring a system with options selected according to user input;
enabling a user to authorize access to the information handling system to provide support for the information handling system; and
receiving information from the support authorization module regarding whether remote access of the information handling system is authorized.

9. The method of claim 8 further comprising:
providing the user with an incentive to authorize a relaxed privacy arrangement.

10. The method of claim 9 wherein:
the incentive relates to support of the information handling system.

11. The method of claim 9 wherein:
the incentive includes an extended service period for which support is provided.

12. The method of claim 9 wherein:
the incentive includes a reduced cost extended service plan for support of the information handling system.

13. The method of claim 8 further comprising
enabling a user to authorize support based upon the options selected according to user input.

14. The method of claim 8 further comprising
generating information relating to the support authorized by the user.

15. An apparatus for enabling configuration of an information handling system comprising:
means for configuring a system with options selected according to user input;
means for enabling a user to authorize access to the information handling system to provide support for the information handling system; and
means for receiving information from the support authorization module regarding whether remote access of the information handling system is authorized.

16. The apparatus of claim 15 further comprising:
means for providing the user with an incentive to authorize a relaxed privacy arrangement.

17. The apparatus of claim 16 wherein:
the incentive relates to support of the information handling system.

18. The apparatus of claim 16 wherein:
the incentive includes an extended service period for which support is provided.

19. The apparatus of claim 16 wherein:
the incentive includes a reduced cost extended service plan for support of the information handling system.

20. The apparatus of claim 15 further comprising
means for enabling a user to authorize support based upon the options selected according to user input.

21. The apparatus of claim 15 further comprising
means for generating information relating to the support authorized by the user.
